(19) United States
(12) Patent Application Publication
(10) Pub. No.: US 2025/0094554 A1
(43) Pub. Date: Mar. 20, 2025

(54) CORNEA-BASED BIOMETRIC AUTHENTICATION

(71) Applicant: FINGERPRINT CARDS ANACATUM IP AB, GÖTEBORG (SE)

(72) Inventors: Gabriel HINE, ROME (IT); Mikkel STEGMANN, VANLØSE (DK)

(73) Assignee: FINGERPRINT CARDS ANACATUM IP AB, GÖTEBORG (SE)

(21) Appl. No.: 18/728,161

(22) PCT Filed: Jan. 30, 2023
(86) PCT No.: PCT/SE2023/050077

§ 371 Date: Jul. 11, 2024

(30) Foreign Application Priority Data
Feb. 3, 2022 (SE) 2250103-5

(51) Int. Cl. G06F 21/32; G06V 40/16; G06V 40/18; G06V 40/19; G06V 40/40

(52) U.S. Cl. CPC G06F 21/32; G06V 40/171; G06V 40/172; G06V 40/19; G06V 40/193; G06V 40/197; G06V 40/40

(57) ABSTRACT

The present disclosure relates to a method of authenticating an individual using biometric information of an eye of the individual, and a biometric recognition system performing the method. In an aspect, a method of a biometric recognition system of authenticating an individual using biometric information of an eye of the individual is provided. The method comprises capturing at least one image comprising a representation of an iris of the individual, which at least one image is captured utilizing polarized light reflected at the iris and received at a polarization-sensitive camera capturing said at least one image, detecting, from the representation, birefringent features of a cornea of the individual, comparing the detected birefringent cornea features with previously enrolled birefringent cornea features and if there is a match authenticating the individual.

### TECHNICAL FIELD

The present disclosure relates to a method of authenticating an individual using biometric information of an eye of the individual, and a biometric recognition system performing the method.

### BACKGROUND

When capturing images of an eye of a user for performing iris recognition using for instance a camera of a smartphone for subsequently unlocking the smart phone of the user, subtle visual structures and features of the user's iris are identified in the captured image and compared to corresponding features of a previously enrolled iris image in order to find a match. These structures are a strong carrier of eye identity, and by association, subject identity.

Both during authentication and enrolment of the user, accurate detection of these features is pivotal for performing reliable iris recognition. However, iris recognition is susceptible to spoofing where an attacker e.g. may present a credible and detailed iris printout to an iris recognition system for attaining false authentication.

### SUMMARY

One objective is to solve, or at least mitigate, this problem in the art and provide an improved method of authenticating an individual using biometric information of an eye of the individual.

This objective is attained in a first aspect by a method of a biometric recognition system of authenticating an individual using biometric information of an eye of the individual. The method comprises capturing at least one image comprising a representation of an iris of the individual, which at least one image is captured utilizing polarized light reflected at the iris and received at a polarization-sensitive camera capturing said at least one image, detecting, from the representation, birefringent features of a cornea of the individual, comparing the detected birefringent cornea features with previously enrolled birefringent cornea features and if there is a match authenticating (S104) the individual (100).

This objective is attained in a second aspect by a biometric recognition system configured to authenticate an individual using biometric information of an eye of the individual, the system comprising a polarization-sensitive camera configured to capture at least one image comprising a representation of an iris of the individual, which at least one image is captured utilizing polarized light reflected at the iris and received at the polarization-sensitive camera. The system further comprises a processing unit configured to detect, from the representation, birefringent features of a cornea of the individual, compare the detected birefringent cornea features with previously enrolled birefringent cornea features and if there is a match to authenticate the individual.

Thus, by subjecting the iris of the individual to polarized light and capturing an image of the iris with a polarization-sensitive camera, so-called birefringent features of the cornea covering the iris will be present in the image, which birefringent cornea features are matched to previously enrolled birefringent cornea features to authenticate the individual.

Advantageously, not only is authentication provided utilizing the birefringent cornea features but real-eye detection is also enabled since a spoof eye, such as a paper printout, will not exhibit the birefringent cornea features and authentication will fail

In an embodiment, it is thus determined that the representation of the iris originates from a non-authentic iris if no birefringent features of the cornea are detected from the representation.

In an embodiment, the polarization if light is caused by emitting light through a first polarization filter having a first set of polarization properties, and the polarization sensitivity is caused by receiving the polarized light reflected by the iris at the camera via a second polarization filter having a second set of polarization properties.

In an embodiment, at least one image is being captured comprising a representation of an iris of the individual and further a representation of a face or periocular region of the individual, wherein the method further comprises detecting, from the acquired representation, face or periocular features of the individual and comparing the detected face or periocular features with previously enrolled face or periocular features, and if there is a match the individual is authenticated.

In an embodiment, a further, unpolarized image is captured comprising a representation of the iris, face or periocular region of the individual from which the iris, face or periocular features are detected.

In an embodiment, a further image is captured using a different polarization configuration than the polarization utilized when capturing said at least one image and then said further image is combined with said at least one image to reconstruct an unpolarized image comprising a representation of the iris, face or periocular region of the individual from which the iris, face or periocular features are detected.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects and embodiments are now described, by way of example, with reference to the accompanying drawings, in which:

FIG. 1 illustrates a user being located in front of a smart phone, in which embodiments may be implemented;

FIG. 2 shows a camera image sensor being part of an iris recognition system according to an embodiment;

FIG. 3a illustrates a user being subjected to unpolarized light for iris image capture;

FIG. 3b illustrates a user being subjected to polarized light for iris image capture by a polarization-sensitive camera according to an embodiment;

FIG. 4a illustrates an eye being subjected to unpolarized light;

FIG. 4b illustrates an eye being subjected to polarized light where a polarization-sensitive camera will capture images comprising birefringent features of the cornea according to an embodiment;

FIG. 4c illustrates different appearances of birefringent features of the cornea of the user when selecting different sets of polarization properties of polarizing filters;

FIG. 5 shows a flowchart of a method of authenticating an individual using biometric information of an eye of the individual according to an embodiment;

FIG. 6 illustrates three different authentication responses (a)-(c) according to embodiments;

FIG. 7 shows a flowchart of a method of authenticating an individual using biometric information of an eye of the individual according to a further embodiment; and

FIG. 8 shows a flowchart of a method of authenticating an individual using biometric information of an eye of the individual according to yet an embodiment.

### DETAILED DESCRIPTION

The aspects of the present disclosure will now be described more fully hereinafter with reference to the accompanying drawings, in which certain embodiments of the invention are shown.

These aspects may, however, be embodied in many different forms and should not be construed as limiting; rather, these embodiments are provided by way of example so that this disclosure will be thorough and complete, and to fully convey the scope of all aspects of invention to those skilled in the art. Like numbers refer to like elements throughout the description.

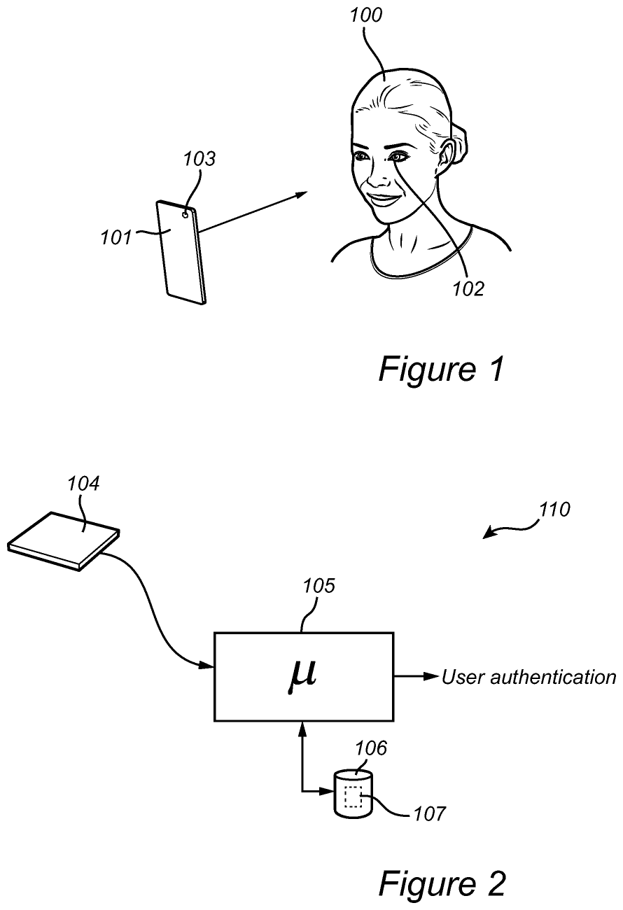

FIG. 1 illustrates a user 100 being located in front of a smart phone 101. In order to unlock the smart phone 101, a camera 103 of the smart phone 101 is used to capture one or more images of an eye 102 of the user 100.

After having captured the image(s), the user's iris is identified in the image(s) and unique features of the iris are extracted from the image and compared to features of an iris image previously captured during enrolment of the user 100. If the iris features of the currently captured image—at least to a sufficiently high degree—correspond to those of the previously enrolled image, there is a match and the user 100 is authenticated. The smart phone 101 is hence unlocked.

It should be noted that this is exemplifying only, and that authentication may be utilized for numerous purposes, such as e.g. unlocking a vehicle to be entered by a user, allowing a user to enter a building, to perform a purchase at a point-of-sale terminal, etc, using appropriately adapted iris recognition systems.

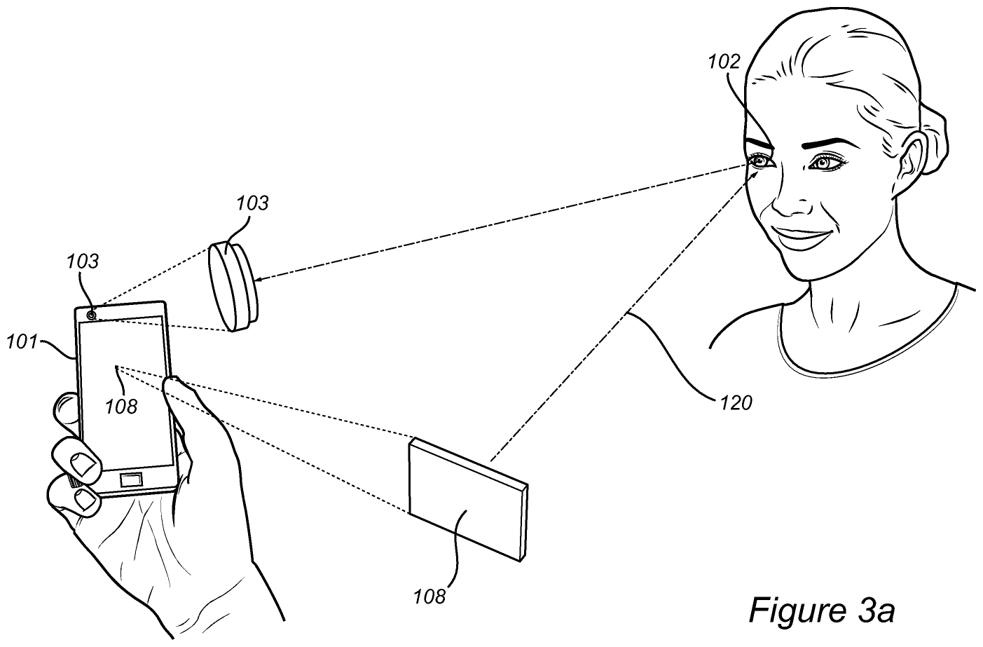

FIG. 2 shows a camera image sensor 104 being part of a biometric recognition system 110 according to an embodiment implemented in e.g. the smart phone 101 of FIG. 1. The system will be referred to as an iris recognition system but may alternatively be used to recognize face- or periocular features of an individual. The iris recognition system 110 comprises the image sensor 104 and a processing unit 105, such as one or more microprocessors, for controlling the image sensor 104 and for analysing captured images of one or both of the eyes 102 of the user 100. The iris recognition system 110 further comprises a memory 106. The iris recognition system 110 in turn, typically, forms part of the smart phone 100 as exemplified in FIG. 1.

The camera 103 will capture an image of the user's eye 102 resulting in a representation of the eye being created by the image sensor 104 in order to have the processing unit 105 determine whether the iris data extracted by the processing unit 105 from image sensor data corresponds to the iris of an authorised user or not by comparing the iris image to one or more authorised previously enrolled iris templates pre-stored in the memory 106.

With reference again to FIG. 2, the steps of the method performed by the iris recognition system 110 are in practice performed by the processing unit 105 embodied in the form of one or more microprocessors arranged to execute a computer program 107 downloaded to the storage medium 106 associated with the microprocessor, such as a RAM, a Flash memory or a hard disk drive. Alternatively, the computer program is included in the memory (being for instance a NOR flash) during manufacturing. The processing unit 105 is arranged to cause the iris recognition system 110 to carry out the method according to embodiments when the appropriate computer program 107 comprising computer-executable instructions is downloaded to the storage medium 106 and executed by the processing unit 105. The storage medium 106 may also be a computer program product comprising the computer program 107. Alternatively, the computer program 107 may be transferred to the storage medium 106 by means of a suitable computer program product, such as a Digital Versatile Disc (DVD) or a memory stick. As a further alternative, the computer program 107 may be downloaded to the storage medium 106 over a network. The processing unit 105 may alternatively be embodied in the form of a digital signal processor (DSP), an application specific integrated circuit (ASIC), a field-programmable gate array (FPGA), a complex programmable logic device (CPLD), etc.

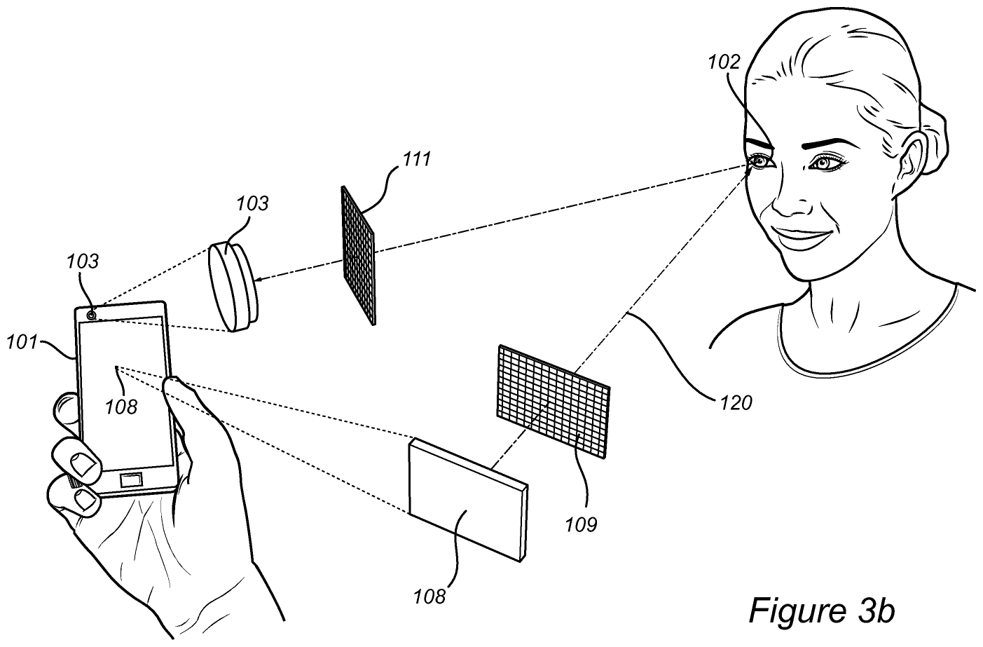

Now, with reference to FIG. 3a, in an example it is assumed that unpolarized light 120 is being emitted e.g. by light-emitting elements 108 of a screen of the smart phone 101 or by a camera flash travelling in a path from the smart phone 101 to the eye 102 of the user and back to an image sensor of the camera 103.

In FIG. 3b, it is assumed that the emitted light 120 travelling in a path from the smart phone 101 to the eye 102 of the user and back to the image sensor of the camera 103 is polarized. In this particular example, the polarization of the light 120 is caused by a first polarizing filter 109 arranged at the light-emitting elements 108, for instance being implemented in the form of a polarizing film attached to the screen of the smart phone 101. Further in FIG. 3b, a second polarizing filter 111 is arranged at the camera 103, for instance being implemented in the form of a polarizing film attached to a lens of the camera 103.

Thus, the camera 103 must be polarization-sensitive in order to be able to perceive the polarized light 120 being reflected against the eye 102 and impinging on the image sensor of the camera 103.

In practice, the image sensor 104 of FIG. 2 may be a polarization image sensor where pixel responses vary according to polarization characteristics of the light impinging on the sensor. In other words, an image sensor which is intrinsically selective to polarization by means of a polarizer (i.e. equivalent to the second filter 111 being arranged inside the camera 103 at the image sensor 104) may advantageously be utilized. However, for illustrative purposes, a separate polarization filter 111 is used, which also may be envisaged in a practical implementation as a less expensive alternative to the polarization image sensor.

Now, a human cornea—i.e. the outer membrane in front of the iris—exhibits birefringent properties that are apparent in a captured image when the iris is illuminated with polarized light and the image is captured with a polarization-sensitive camera 103.

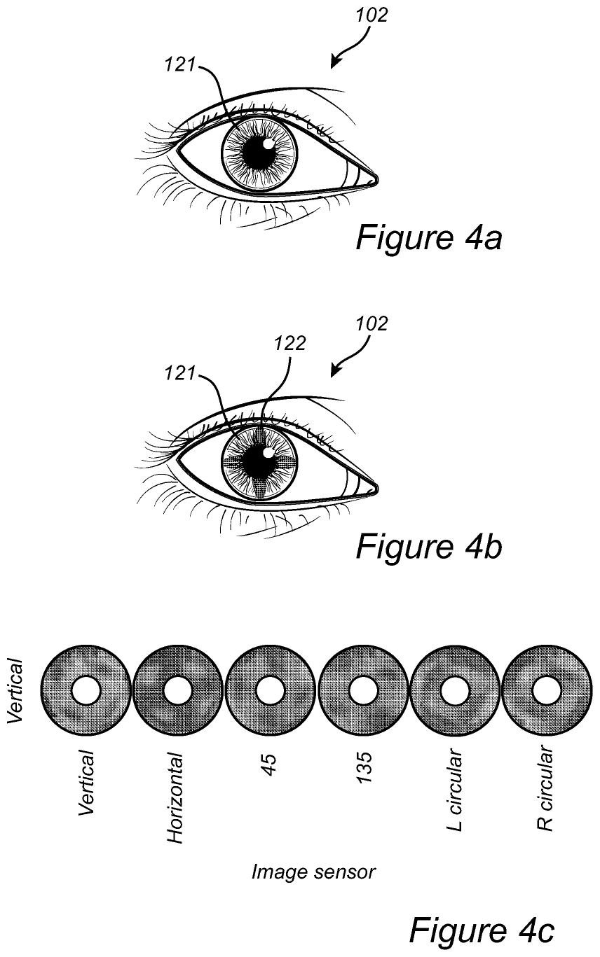

Thus, as shown in FIG. 4a corresponding to the scenario of FIG. 3a where the eye 102 is subjected to unpolarized light, a “normal” iris 121 is present in the image captured by the camera 103 whereas in FIG. 4b corresponding to the scenario of FIG. 3b where the eye 102 is subjected to polarized light, birefringent features 122 of the cornea are present in the image captured by the polarization-sensitive camera 103 caused by the polarized light impinging on the cornea covering the iris 121. As is understood, should a camera be used which is not polarization-sensitive, the birefringent features will not be present in the captured image, even if the light 120 travelling towards the eye is polarized.

These birefringent features 122 are distinctive to the user 102 and will have different appearances depending on the polarization configuration used.

FIG. 4c illustrates different appearances of birefringent features of the cornea of the user 102 in case of the light emitted by the light-emitting elements 108 is vertically polarized by the first polarizing filter 109 while the light received at the camera 103 is vertically, horizontally, 45°, 135°, left circularly and right circularly polarized, respectively, by the second polarizing filter 111 (or by an intrinsic polarizer in case a polarization image sensor is used). As is understood, the first polarizing filter 109 could also be configured to have any one of a vertically, horizontally, 45°, 135°, left circularly and right circularly polarization, which in this particular example potentially would result in 6×6=36 different appearances of the birefringent cornea features,

Thus, the first polarization filter 109 has a first set of polarization properties while the second polarization filter 111 has a second set of polarization properties. As is understood, the first polarization filter 109 and the second polarization filter 111 may e.g. both vertically polarize any light passing through in which case the two filters 109, 111 would have the same set of polarization properties.

Thus, depending on the polarization configuration of the light emitted by the smart phone 101 and the polarization configuration selected for the light received by the camera 103 (as determined by the first and second polarizing filters 109, 111, respectively), the birefringent features will have different appearances. However, a user will typically exhibit characteristic birefringent features for each given configuration, from which characteristic birefringent features the user may be recognized.

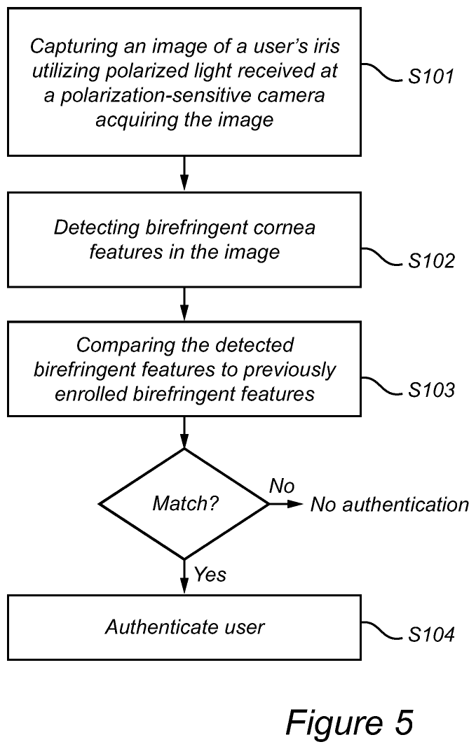

In an embodiment, this is exploited to authenticate an individual, for instance with the purpose of e.g. unlocking the smart phone 101 or allow a user to start a car in case the system is implemented in the car. Reference is made to FIG. 5 showing a flowchart of a method of authenticating an individual using biometric information of an eye of the individual according to an embodiment.

In a first step S101, the polarization-sensitive camera 103 is controlled (typically by the processing unit 105) to capture an image of an iris 121 of the individual 100, which image is captured utilizing polarization of light received at the image sensor 104 of the camera 103. As previously discussed, in this example the polarization is caused by the first polarizing filter 109, while the second polarization filter 111 causes the camera 103 to become polarization-sensitive (although a polarization image sensor may be used as previously discussed).

By polarizing the light 120 impinging on the eye 102 of the individual 100 in combination with utilizing a polarization-sensitive camera 103, birefringent features 122 of the cornea of the eye 102 will be present in the captured image of the iris 121, which birefringent features 122 are detected by the processing unit 105 in step S102. As previously illustrated in FIG. 4c, the appearance of the birefringent features depends on the combination of polarization properties selected for the first polarizing filter 109 and the second polarizing filter 111.

Similar to the discussion in connection to FIG. 2, iris image(s) are captured during enrolment of the user 100 and birefringent features of the cornea are extracted from these images to create one or more cornea birefringence templates to be pre-stored in the memory 106.

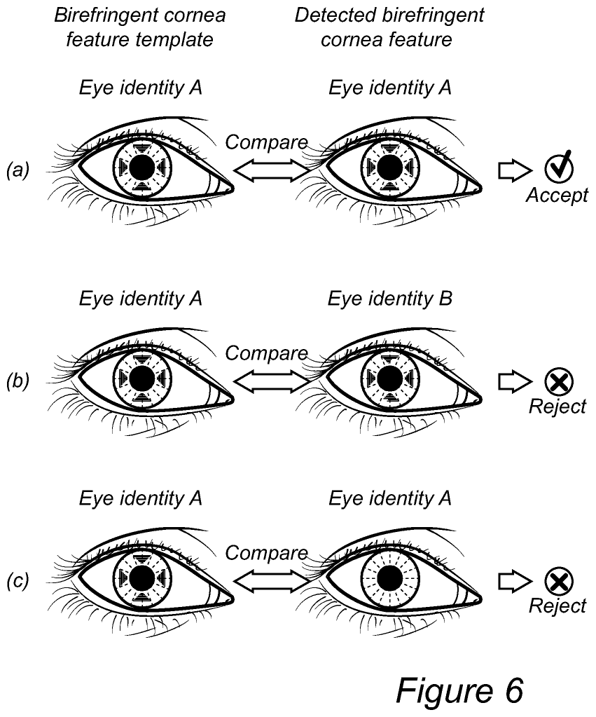

FIG. 6 illustrate three different authentication scenarios to which reference will be made.

In first scenario (a), the birefringent cornea features detected in step S102 from the image captured in step S101 is compared in step S103 to the previously enrolled birefringent cornea features of the templates stored in the memory 106 and since in this scenario there is a match between the detected birefringent features and the previously enrolled birefringent features, the user is authenticated in step S104. In other words, the identity of the user 100 associated with the detected birefringent features of step S102 must indeed correspond to identity A associated with the birefringent feature template pre-stored in the memory 106.

In second scenario (b), the birefringent cornea features detected in step S102 from the image captured in step S101 is compared in step S103 to the previously enrolled birefringent cornea features of the templates stored in the memory 106. However, since the detected birefringent features do not match the birefringent feature template in step S103, authentication is not successful. Thus, the detected birefringent features of step S102 cannot correspond to enrolled identity A but rather a different identity, in this example denoted identity B. As a result, the user is rejected.

In third scenario (c), an attempt is made in step S102 to detect birefringent cornea features from the image captured in step S101 and perform the comparison in step S103 to the previously enrolled birefringent cornea features of the templates stored in the memory 106. In this particular example, the system 110 is subjected to a spoof attempt where an attacker presents e.g. a printout of a user's iris. It should be noted that iris features of this printout nevertheless may correspond perfectly to those of the user.

However, such a printout will not comprise the birefringent cornea features of the stored birefringent cornea feature template (to the far left) and even if the printout iris features indeed would be identical to the enrolled iris features, authentication will fail since the printout lacks birefringent cornea features to be matched against the pre-stored birefringent cornea feature template. Advantageously, performing authentication based on birefringent cornea features also provides for real-eye detection. That is, only an authentic eye will exhibit birefringent cornea features and if no birefringent cornea features are detected in step 102, it may also be determined in step S104 that a non-authentic iris must have been presented to the camera 103 in step S101.

In a further embodiment, in addition to performing authentication based on detected birefringent cornea features, detected biometric features of the captured image(s) may also be considered.

It is noted that birefringent features of the cornea typically are less expressive than face features and even more so when compared to iris features. Thus, in a scenario where high security and reliability is required in the authentication process, the birefringent cornea feature detection described hereinabove is expanded upon such that iris feature detection and/or face feature detection and subsequent iris/face feature authentication further is undertaken.

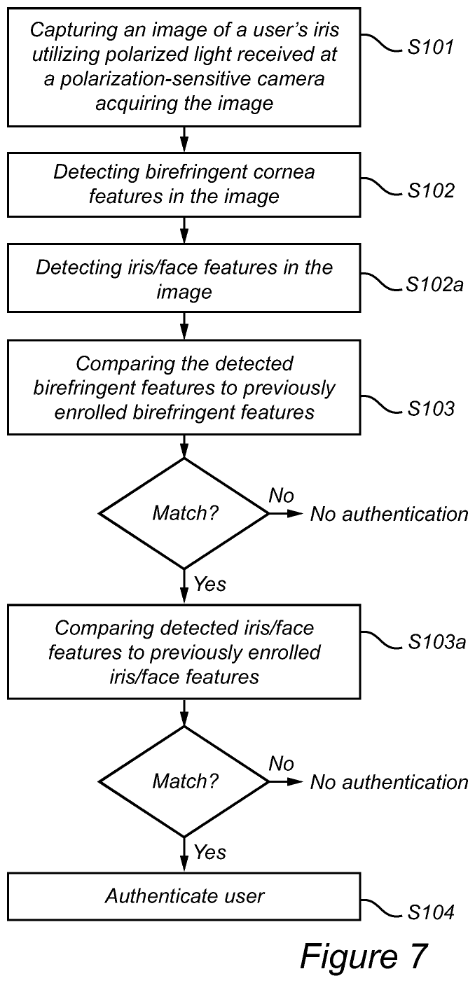

FIG. 7 shows a flowchart of a method of authenticating an individual using biometric information of an eye of the individual according to an embodiment.

Similar to FIG. 5, in a first step S101, the polarization-sensitive camera 103 is controlled (typically by the processing unit 105) to capture an image of an iris 121 of the individual 100, which image is captured utilizing polarized light received at the image sensor 104 of the camera 103. As previously discussed, in this example the polarization is caused by the first polarizing filter 109.

As is understood, if face features are to be used to authenticate the user 100, the image should be captured such that at least a part of the user's face is present in the captured image.

Birefringent cornea features 122 will thus be present in the captured image of the iris 121, which birefringent cornea features 122 are detected by the processing unit 105 in step S102.

Further in this embodiment, iris or face features are detected in the captured image in step S102a. It is noted that the detection of iris and/or face features not necessarily is affected by the polarization filters 109, 111. For instance, as illustrated in FIG. 4b, features of the iris 121 will be present in a captured image along with birefringent cornea features 122.

As previously described, the birefringent cornea features detected in step S102 from the image captured in step S101 is compared in step S103 to the previously enrolled birefringent cornea features of the templates stored in the memory 106 and since in this scenario there is a match between the detected birefringent features and the previously enrolled birefringent features, the process proceeds to step S103a where the detected iris/face features of step S102a is compared to previously enrolled iris/face feature template(s).

If there is a match also for the compared iris/face features, the user 100 is authenticated in step S104. Advantageously, not only is the level of security and reliability raised in the authentication process, but liveness detection is further provided by means of the birefringent cornea feature detection. In other words, if the presented iris is a spoof, no birefringent cornea features will be detected and the authentication will be terminated in the match operation undertaken just after step S103.

Further envisaged biometric features to be utilized include those in the so-called periocular region, which is the area around the eye including features like eyelashes, eyebrows, eyelids, eye shape, tear duct, skin texture, etc.

In a further embodiment, if it is problematic to detect iris/face/periocular features from the captured image polarized image due to the refringent cornea features also being present, a further image not subjected to polarization is captured.

This may be performed by implementing either the first polarization filter 109 or the second polarization filter 111 (or both) using variable-polarization filter(s), where the polarization configuration of each filter may be adjusted or even removed.

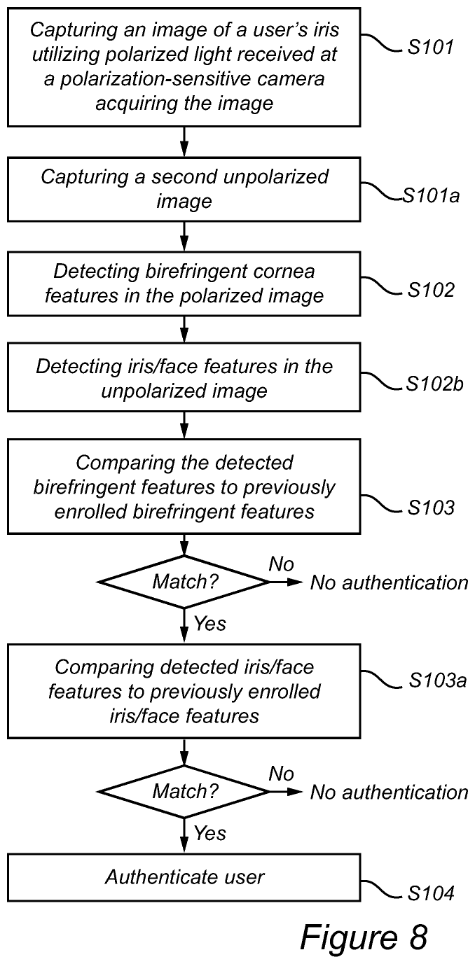

If so, with reference to the flowchart of FIG. 8, a further, second image is captured by the camera 103 in step S101a where either the eye is subjected to unpolarized light 120 or the camera 103 is caused to be non-sensitive to polarized light (e.g. by not polarizing the first and/or second filters 109, 111).

The difference from the flowchart of FIG. 7 is then that the iris/face/periocular features are detected in step S102b in the unpolarized image to avoid any birefringent cornea features being present.

Alternatively, if the birefringent cornea features detected in step S102 from an image being subjected to polarized light as captured in step S101 matches a birefringent feature template in the comparison of step S103, the second unpolarized image is captured thereafter and the iris/face/periocular features are detected in the second unpolarized image. Thus, in such case, steps S101a and S102b are performed after the match decision is taken for the birefringent cornea features.

In an alternative, an unpolarized image may be reconstructed by combining multiple polarized images. For example, the first image may be captured in step S101 obtained with orthogonal polarizers (e.g. first filter 109 at 0° degrees and second filter 111 at 90°), in which the birefringent cornea features are detected. A further image may be captured using parallel polarizers (e.g. both the first filter 109 and the second filter 111 at 0°). These two polarized images are then combined to create an unpolarized image from which the iris/face/periocular features are detected, for instance by accumulating the image data of one of the images with the image data of other.

The aspects of the present disclosure have mainly been described above with reference to a few embodiments and examples thereof. However, as is readily appreciated by a person skilled in the art, other embodiments than the ones disclosed above are equally possible within the scope of the invention, as defined by the appended patent claims.

Thus, while various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method of a biometric recognition system of authenticating an individual using biometric information of an eye of the individual, comprising:
capturing at least one image comprising a representation of an iris of the individual, which at least one image is captured utilizing polarized light reflected at the iris and received at a polarization-sensitive camera capturing said at least one image;
detecting, from the representation, birefringent features of a cornea of the individual;
comparing the detected birefringent cornea features with previously enrolled birefringent cornea features; and if there is a match:
authenticating the individual.

2. The method of claim 1, further comprising:
determining that the representation of the iris originates from a non-authentic iris if no birefringent features of the cornea are detected from the representation.

3. The method of claim 1, wherein the polarization if light is caused by:
emitting light through a first polarization filter having a first set of polarization properties; and the polarization sensitivity being caused by:
receiving the polarized light reflected by the iris at the camera via a second polarization filter having a second set of polarization properties.

4. The method of claim 1, further comprising:
detecting, from the acquired representation, iris features of the individual;
comparing the detected iris features with previously enrolled iris features; and if there is a match the individual is authenticated.

5. The method of claim 1, wherein the at least one image being captured comprising a representation of an iris of the individual further comprises a representation of a face or periocular region of the individual, the method further comprising:
detecting, from the acquired representation, face or periocular features of the individual;
comparing the detected face or periocular features with previously enrolled face or periocular features; and if there is a match the individual is authenticated.

6. The method of claim 4, further comprising:
capturing a further, unpolarized image comprising a representation of the iris, face or periocular region of the individual from which the iris, face or periocular features are detected.

7. The method of claim 4, further comprising:
capturing a further image using a different polarization configuration than the polarization utilized when capturing said at least one image; and
combining said further image and said at least one image to reconstruct an unpolarized image comprising a representation of the iris, face or periocular region of the individual from which the iris, face or periocular features are detected.

8. (canceled)

9. A computer program product comprising a non-transitory computer readable medium, the computer readable medium having a computer program embodied thereon, the computer program comprising computer-executable instructions for causing a biometric recognition system to perform the method of claim 1 when the computer-executable instructions are executed on a processing unit included in the biometric recognition system.

10. A biometric recognition system configured to authenticate an individual using biometric information of an eye of the individual, the system comprising a polarization-sensitive camera configured to:
capture at least one image comprising a representation of an iris of the individual, which at least one image is captured utilizing polarized light reflected at the iris and received at the polarization-sensitive camera; the system further comprising a processing unit configured to:
detect, from the representation, birefringent features of a cornea of the individual;
compare the detected birefringent cornea features with previously enrolled birefringent cornea features; and if there is a match:
authenticate the individual.

11. The biometric recognition system of claim 10, the processing unit further being configured to:
determine that the representation of the iris originates from a non-authentic iris if no birefringent features of the cornea are detected from the representation.

12. The biometric recognition system of claim 10, wherein the polarization if light is caused by the system being configured to:
emit light through a first polarization filter having a first set of polarization properties; and the polarization sensitivity being caused by the system being configured to:
receive the polarized light reflected by the iris at the camera via a second polarization filter having a second set of polarization properties.

13. The biometric recognition system of claim 10, the processing unit further being configured to:
detect, from the acquired representation, iris features of the individual;
compare the detected iris features with previously enrolled iris features; and if there is a match the individual is authenticated.

14. The biometric recognition system of claim 10, wherein the at least one image being captured comprising a representation of an iris of the individual further comprises a representation of a face or periocular region of the individual, the method further comprising:
detecting, from the acquired representation, face or periocular features of the individual;
comparing the detected face or periocular features with previously enrolled face or periocular features; and if there is a match the individual is authenticated.

15. The biometric recognition system of claim 13, the camera further being configured to:
capture a further, unpolarized image comprising a representation of the iris, face or periocular region of the individual from which the iris, face or periocular features are detected.

16. The biometric recognition system of claim 13, the camera further being configured to:
capture a further image using a different polarization configuration than the polarization utilized when capturing said at least one image; and the processing unit further being configured to:
combine said further image and said at least one image to reconstruct an unpolarized image comprising a representation of the iris, face or periocular region of the individual from which the iris, face or periocular features are detected.
